(19) United States
(12) Patent Application Publication
(10) Pub. No.: US 2025/0368121 A1
(43) Pub. Date: Dec. 4, 2025

(54) Ratchet Strap and Storage Device

(71) Applicant: Scott Greene, Minneapolis, MN (US)

(72) Inventor: Scott Greene, Minneapolis, MN (US)

(21) Appl. No.: 19/096,783

(22) Filed: Apr. 1, 2025

Related U.S. Application Data
(60) Provisional application No. 63/652,724, filed on May 29, 2024.

(51) Int. Cl. B60P 7/08

(52) U.S. Cl. CPC B60P 7/0846

(57) ABSTRACT

A ratchet strap storage device is disclosed for safely and efficiently wrapping, storing, and retrieving a ratchet strap while also securing excess webbing. The ratchet strap storage device comprises a body component that is configured in a “H” or balbis shape and comprised of a left leg and left leg apertures, a right leg and right leg apertures, a bottom surface, a top surface, and an attachment point. The ratchet strap storage device further comprises a securing feature designed to hold the ratchet strap, webbing, and/or slack to a body of the ratchet strap storage device. The strap can be easily wrapped around the center portion of the “H” or balbis shaped body, between the left and right leg, and secured to the body by threading one or more securing features or tie downs through the holes or notches (i.e., apertures) in the legs.

### CROSS-REFERENCE TO RELATED APPLICATION

The present application claims priority to, and the benefit of, U.S. Provisional Application No. 63/652,724, which was filed on May 29, 2024, and is incorporated herein by reference in its entirety.

### FIELD OF THE INVENTION

The present invention relates generally to the field of ratchet strap storage and securing devices. More specifically, the present invention relates to a ratchet strap storage device that provides a structured solution for organizing, securing, and storing of excess webbing (or slack) from ratchet straps, whether during transportation, on a job site, or in storage locations. The present invention mitigates safety hazards associated with loose straps, webbing or slack, prevents damage, and enhances efficiency in handling ratchet straps. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in the storage, use, and cleanup of ratchet straps. Ratchet straps are widely used for securing loads, and generally, ratchet straps are long in length and clean up and storage of such items can be difficult, and their excess webbing presents multiple challenges. Traditional storage methods, such as manually coiling and loosely bundling the straps, often lead to a loose pile of nylon strap (webbing) that can be easily tangled, causing tripping hazards, unnecessary wear, and take up valuable space in storage. Further even if the user takes time to bundle neatly, the strap will not stay in that position for long periods of time, as there is nothing to hold it in place. Users frequently struggle with securing slack during transport, it can take a long time to secure same, and often doesn't follow a standard process for securing the slack which can result in flapping webbing, damage, or entanglement with moving parts such as trailer tires. Furthermore, without a standardized method for storage, straps are often thrown into piles, reducing their lifespan due to abrasion and exposure to environmental elements. Existing solutions fail to provide an efficient, compact, and durable means of securing both the ratchet strap and its excess slack. Therefore, there is a longstanding need for a device that simplifies storage, prevents entanglement, and extends the operational life of ratchet straps by reducing unnecessary wear.

Further when the user has multiple straps to store as is the case in construction applications, the straps often become tangled. When this happens, the user is forced to take time to untangle the straps before use, wasting time. Without a way to properly wrap and store the straps the users will often find themselves untangling straps and spending more time prepping on the job site than actually performing work.

Furthermore, straps are usually made of a nylon type material, and as such are subject to wear. Many straps are rated for weight and have specific safety features built into them to identify when wear has compromised the integrity of the strap. When straps are thrown into a pile, they often have other items thrown on top of them and are usually pulled out of a pile of other items for retrieval by the user. Additionally, excess webbing or slack, if not secured properly when transporting an object, can flap in the wind leading to premature wear and entanglement hazards (i.e., caught in a trailer tire). This excess wear can limit the life of the strap and can in some cases cause failure of the strap in use.

Accordingly, there is a demand for a device that will wrap up and store a ratchet strap properly and assists the user in storage and retrieval. More particularly there is a demand for a device that will wrap up and store a ratchet device, including excess webbing or slack, that provides a safe working environment for the user and their work colleagues.

Therefore, there exists a long-felt need in the art for a ratchet strap storage device that provides users with an easy way to clean up, store and retrieve their ratchet straps. There is also a long-felt need in the art for a ratchet strap storage device designed with a quick release tie down that enables the user to quickly access the ratchet strap. Further there is a long-felt need in the art for a ratchet strap storage device that has a base that can be attached to an existing storage location such as a hook or loop. Moreover, there is a long-felt need in the art for a ratchet strap storage device that enables the user to store the straps so as to eliminate wear on the strap and lengthen the useful life of the strap and prevent possible failure while in use. Further still, there exists a need for a ratchet strap storage device that can safely secure slack when transporting an object.

The subject matter disclosed and claimed herein, in one embodiment thereof, comprises a ratchet strap storage device. The device is a ratchet strap storage device for organizing, cleaning up, storing, and retrieving ratchet straps of different sizes and shapes. The device is comprised of a body component that is configured in a general “H” or balbis shape with a plurality of holes or notches (i.e., 6 apertures) located along the longer side. The holes or notches (i.e., apertures) are located, for example, in a pattern of three on each side with the three apertures being configured generally in a straight line. The device also comprises at least one tie down designed to be placed through the holes or notches (i.e., apertures) to hold the strap in place once its wound around the “H” or balbis shaped base. Further the base may contain an attachment feature that enables the user to store the entire device and ratchet strap on an existing storage location.

In this manner, the ratchet strap storage device of the present invention accomplishes all the forgoing objectives and provides users with a device that provides a manner to clean up, store and retrieve a ratchet strap ensuring that the strap is safely secured and reduces damage to the ratchet strap itself.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a ratchet strap storage device. The device is a ratchet strap storage device for wrapping up, storing and retrieving ratchet straps. The device is comprised of a body component that is configured in a general “H” or balbis shape with a plurality of holes or notches (i.e., 6 apertures) located along the longer side, The holes or notches (i.e., apertures) are located, for example, in a pattern of three on each side with the three apertures being configured generally in a straight line. The device also comprises at least one tie down designed to be placed through the holes or notches (i.e., apertures) to hold the strap in place once its wound around the “H” or balbis shaped base. Further the base may contain an attachment feature that enables the user to store the entire device and ratchet strap on an existing storage location.

The present invention is directed to a ratchet strap storage device that has particular utility storing ratchet straps neatly and, in a position to eliminate damage and tripping hazards. In the present invention the device can be used with any size strap to wind around the base and provide a neat secure location for the ratchet strap. Although the device may be laid flat, the device could also be hung from an existing mounting point. The device describes a tie down type of fastener to securely hold the ratchet strap on the device, any type of fastener may be used that enables for the easy securing and retrieval of the strap.

In one embodiment the ratchet strap storage device comprises a body component that is generally in an “H” or balbis shape configuration, but can be any suitable shape and size as is known in the art. The body component comprises an “H” or balbis shaped body, and the thickness can be any thickness which enables the user to accomplish the task of wrapping, storing, and retrieving the ratchet strap. The body can be made from solid metal, or plastic. The body is also comprised of, for example, a series of holes or notches, three on each longer side of the “H” or balbis shaped base and may be of any shape or size as is known in the art. The holes or notches (i.e., apertures) are configured in a general straight line but may be any configuration that enables for the wrapping, storage, and retrieval of a ratchet strap. The body also comprises an attachment point that can be used to temporarily attach a hook device that may be at the end of the strap.

In one embodiment the ratchet strap storage device comprises a body component that is configured in an “H” or balbis shape, but can be any suitable shape and size as is known in the art. The body further comprises an attachment feature that enables the entire assembly, ratchet strap storage device, and ratchet strap, to be stored on a wall mount or on the side of a truck bed. The attachment feature may be mechanical or magnetic in nature.

In one embodiment the ratchet strap storage device comprises body that is configured in a general “H” or balbis shape. The body also comprises two slots, one on each longer side of the “H” or balbis shaped body, to enable the user to tie down the ratchet strap.

In one embodiment the ratchet strap storing device comprises body that is configured in a general “H” or balbis shape designed to hold multiple ratchet straps. In this configuration the legs would be spread father out creating a wider center for multiple straps.

In one embodiment the securing feature is a clamping mechanism that secures the ratchet strap to the base. The clamping mechanism would move out of the way for the user to wind the strap on the device, then close over the strap to sucre the ratchet strap on the device.

Accordingly, the ratchet strap storage device of the present invention is particularly advantageous as it provides the user with a ratchet strap storage device is easily adjustable, attached, and operated. In this manner, the ratchet strap storage device overcomes the limitations of existing methods and devices used to store ratchet straps safely and enable for easy retrieval known in the art. Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a ratchet strap storage device body of the present invention in accordance with the disclosed architecture;

FIG. 2 illustrates a perspective view of one potential embodiment of a ratchet strap storage device body indicating an attachment point of the present invention in accordance with the disclosed architecture;

FIG. 3 illustrates a perspective view of one potential embodiment of a ratchet strap storage device indicating a securing feature of the present invention in accordance with the disclosed architecture;

FIG. 4 illustrates an enhanced perspective view of one potential embodiment of a ratchet strap storage device showing a fully secured strap with the securing feature of the present invention in accordance with the disclosed architecture;

FIG. 5 illustrates an enhanced perspective view of one potential embodiment of a ratchet strap storage device showing a fully secured ratchet strap with multiple securing features of the present invention in accordance with the disclosed architecture; and

FIG. 6 illustrates a flowchart of a method of using one potential embodiment of a flag stand device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, therefore, there exists a long-felt need in the art for a ratchet strap storage device that provides users with an easy way to clean up, store and retrieve their ratchet straps and safely secure excess slack or webbing. There is also a long-felt need in the art for a ratchet strap storage device designed with a quick release tie down that enables the user to quickly access the ratchet strap. Further there is a long-felt need in the art for a ratchet strap storage device that has a base that can be attached to an existing storage location such as a hook or loop. Moreover, there is a long-felt need in the art for a ratchet strap storage device that enables the user to store the straps as to eliminate wear on the strap and lengthen the useful life of the strap and preventing possible failure while in use.

The present invention, in one exemplary embodiment, is a novel ratchet strap storage device. The ratchet strap storage device comprises a body that is configured in a general “H” or balbis shape and comprised of, for example, a series of six holes or notches, three on each longer side of the body, and an attachment point on the body to secure the starting portion of a strap. The device also includes a securing feature, designed to hold the strap or ratchet device securely to the ratchet strap storage device. The present invention also includes a novel method of using the ratchet strap storage device at a job site or other location. The method includes the steps of providing a ratchet strap storage device with a body and securing feature. The method also comprises attaching the S hook of the strap to the attachment point on the ratchet strap storage device. Further the method comprises wrapping the strap around the center portion of the “H” or balbis shaped body until the entire strap is wrapped up. The method also comprises securing the strap to the ratchet strap storage device using one or more securing features (i.e., quick release tie down). Finally, the method comprises removing the securing features and unwinding the strap from the device.

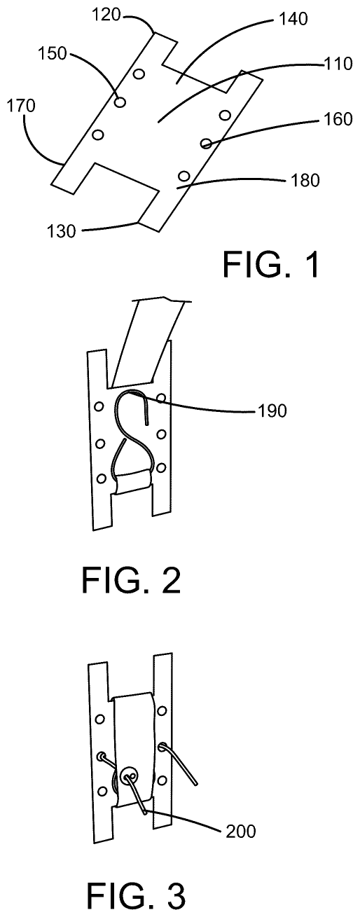

Referring initially to the drawings, FIG. 1 illustrates a perspective view of one embodiment of the body or base 110 of the present invention. In the present embodiment the ratchet strap storage device 100 is a strap storage device 100 that provides the user with a device that will easily clean up, store, and retrieve a ratchet strap. Specifically, the ratchet strap storage device 100 comprises a body or base 110, comprising an “H” or balbis shaped plate having a left leg 120, a right leg 130, and a center portion 140, a top surface 180, and a bottom surface 170. The left leg 120 comprises, for example, three left holes or notches (i.e., apertures) 150, and the right leg 130, comprises three right holes or notches (i.e., apertures) 160.

Referring initially to the drawings, FIG. 2 illustrates a perspective view of the body or base 110, showing the S hook of a strap mating with the attachment point 190 to start the wrapping process.

Referring initially to the drawings, FIG. 3 illustrates a perspective view of ratchet strap securing device 100, illustrating a fully wrapped strap (i.e., ratchet strap wrapped around the body 110). The figure also illustrates at least one securing feature or tie down 200 threaded through the body or base 110 from the left leg 120 of the body or base 110 through to the right leg 130 of the body or base 110.

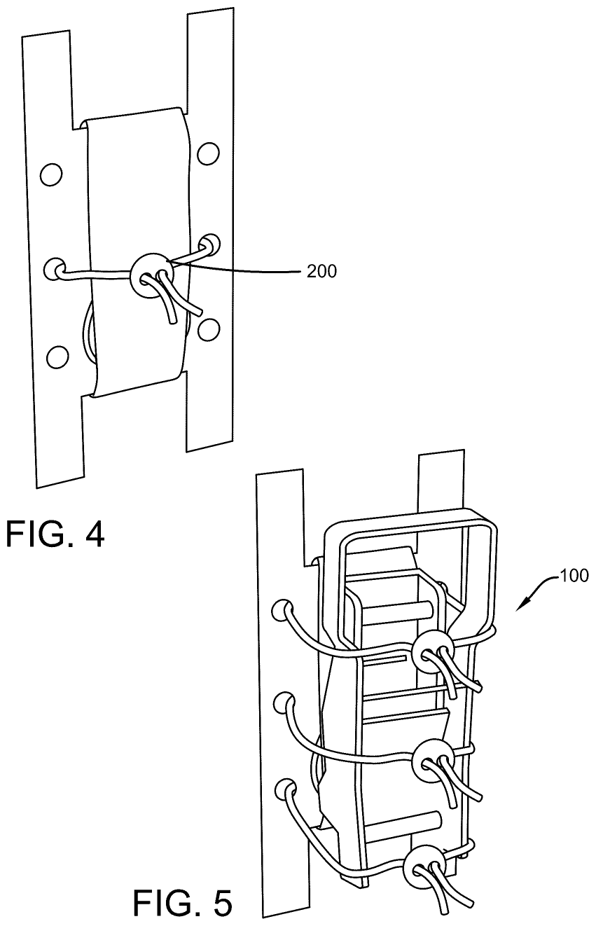

Referring initially to the drawings, FIG. 4 illustrates a perspective view of the device 100 with a strap fully wrapped and secured using at least one securing feature or tie down 200.

Referring initially to the drawings, FIG. 5 illustrates a perspective view of the device 100 with a ratchet strap fully wrapped and secured using multiple securing features or multiple tie downs 200. Each tie down 200 is secured between a left hole or notch 150 and an opposing right hole or notch 160.

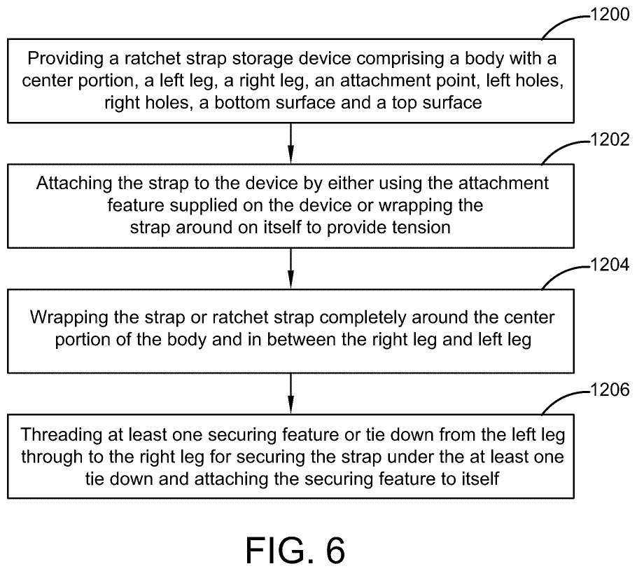

FIG. 6 illustrates a flowchart of the method of using the ratchet strap storage device. The method includes the steps of at 1200, providing a ratchet strap storage device comprising a body with a center portion, a left leg, a right leg, an attachment point, left holes or notches (i.e., apertures), right holes or notches (i.e., apertures), a bottom surface and a top surface, further comprising a securing feature. The method also comprises at 1202 attaching the strap to the device by either using the attachment feature supplied on the device or wrapping the strap around on itself to provide tension. The method also comprises at 1204, wrapping the strap or ratchet strap completely around the center portion of the body and in between the right leg and left leg. The method further comprises at 1206 threading or wrapping at least one securing feature or tie down from the left leg through to the right leg for securing the strap under the at least one tie down and attaching the securing feature to itself.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “ratchet strap storage device” and “device” are interchangeable and refer to the ratchet strap storage device 100 of the present invention.

Notwithstanding the forgoing, the ratchet strap storage device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the ratchet strap storage device 100 as shown in the FIGS. are for illustrative purposes only, and that many other sizes and shapes of the ratchet strap storage device 100 are well within the scope of the present disclosure. Although the dimensions of the ratchet strap storage device 100 are important design parameters for user convenience, the ratchet strap storage device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A ratchet strap storage device comprising:
a strap storage body;
a plate having a left leg, a right leg, a center portion, a top surface, and a bottom surface;
a ratchet strap;
a hook; and
an attachment point;
wherein said ratchet strap attached to said hook at a first terminal end;
wherein said left leg having a plurality of left apertures;
wherein said right leg having a plurality of right apertures;
wherein said hook mating with said attachment point; and
further wherein said ratchet strap wrapped around said strap storage body when said ratchet strap is in a stored position.

2. The ratchet strap storage device of claim 1, wherein said plate having an ‘H’ shape.

3. The ratchet strap storage device of claim 2 further comprising at least one tie down, wherein said at least one tie down secured to one left aperture of said plurality of left apertures and an opposing one right aperture of said plurality of right apertures.

4. The ratchet strap storage device of claim 3, wherein said ratchet strap secured under said at least one tie down.

5. The ratchet strap storage device of claim 4, wherein said plurality of left apertures having at least three left apertures.

6. The ratchet strap storage device of claim 5, wherein said plurality of right apertures having at least three right apertures.

7. The ratchet strap storage device of claim 2 further comprising at least three tie downs, wherein each one of said at least three tie downs secured to one left aperture of said plurality of left apertures and an opposing one right aperture of said plurality of right apertures.

8. The ratchet strap storage device of claim 7, wherein said ratchet strap secured under said at least two tie downs.

9. The ratchet strap storage device of claim 8, wherein said hook having an ‘S’ shape hook.

10. A ratchet strap storage device comprising:
a strap storage body having a plate including a balbis shape with a left leg, a right leg, a center portion, a top surface, and a bottom surface;
a ratchet strap;
a hook;
at least two tie downs; and
an attachment point;
wherein said ratchet strap attached to said hook at a first terminal end;
wherein said left leg having a plurality of left apertures;
wherein said right leg having a plurality of right apertures;
wherein said hook mating with said attachment point;
wherein said ratchet strap wrapped around said strap storage body when said ratchet strap is in a stored position; and
further wherein each one of said at least three tie downs secured to one left aperture of said plurality of left apertures and an opposing one right aperture of said plurality of right apertures.

11. The ratchet strap storage device of claim 10, wherein said ratchet strap secured under said at least two tie downs.

12. The ratchet strap storage device of claim 11, wherein said plurality of left apertures having at least three left apertures.

13. The ratchet strap storage device of claim 12, wherein said plurality of right apertures having at least three right apertures.

14. The ratchet strap storage device of claim 13, wherein said hook having an ‘S’ shape hook.

15. A method of securing a ratchet strap, the method comprising the steps of:
providing a strap storage body having a plate including a left leg, a right leg, a center portion, a top surface, and a bottom surface, a ratchet strap, a hook, an attachment point and at least one tie down, wherein said left leg having a plurality of left apertures and wherein said right leg having a plurality of right apertures;
attaching said ratchet strap to said hook at a first terminal end;
mating said hook with said attachment point;
wrapping said ratchet strap around said strap storage body;
securing said at least one tie down to one left aperture of said plurality of left apertures and an opposing one right aperture of said plurality of right apertures; and
storing said ratchet strap under said at least one tie down.

16. The method of securing a ratchet strap of claim 15, wherein said plate having a balbis shape.

17. The method of securing a ratchet strap of claim 16, wherein said plurality of left apertures having at least three left apertures.

18. The method of securing a ratchet strap of claim 17, wherein said plurality of right apertures having at least three right apertures.

19. The method of securing a ratchet strap of claim 18 further comprising a step of providing at least three tie downs, wherein each one of said at least three tie downs secured to one left aperture of said plurality of left apertures and an opposing one right aperture of said plurality of right apertures.

20. The method of securing a ratchet strap of claim 19, wherein said ratchet strap secured under said at least three tie downs.
